(19) United States
(12) Patent Application Publication
(10) Pub. No.: US 2018/0089478 A1
(43) Pub. Date: Mar. 29, 2018

(54) IDENTIFICATION DEVICE IN THE FORM OF A RING PROVIDED WITH A RADIOFREQUENCY TRANSPONDER

(71) Applicant: I CARE TECHNOLOGIES, AJACCIO (FR)

(72) Inventors: JÉRÉMY NEYROU, PÉRI (FR); FABIEN RAIOLA, PORTO-VECCHIO (FR)

(21) Appl. No.: 15/573,666

(22) PCT Filed: Feb. 3, 2016
(86) PCT No.: PCT/EP2016/052298

§ 371 Date: Nov. 13, 2017

(30) Foreign Application Priority Data
May 13, 2015 (FR) 1554360

(51) Int. Cl. G06K 7/10; G06K 19/077

(52) U.S. Cl. CPC G06K 7/10415; G06K 7/10316; G06K 19/077

(57) ABSTRACT

An identification device includes an annular body with at least one built-in radiofrequency transponder that can emit an electromagnetic field carrying identification information. The identification device includes a masking device that can selectively authorize or block the propagation of the magnetic field emitted by the radiofrequency transponder.

The invention relates to an identification device provided with a radiofrequency transponder for example of the RFID (“Radio Frequency Identification”) and/or NFC (“Near Field Communication”) type having the form of a ring.

The invention can be implemented in any fields requiring an identification or a password for activating the operation of a system, securing access controls such as, but without no limitation thereto, automobile, home automation, for example for opening doors, data processing, and banking transactions.

In the automotive field, developments in automation have made it possible to equip vehicles with a radio-identification starting device. Such a device includes an active transponder periodically emitting an electromagnetic field for remotely communicating with a corresponding radio reader located in a vehicle. For reasons of convenience and space, the starting device comprises a case containing the transponder, such as a RFID RF chip, a micro-antenna, and a source of energy. This source of energy, generally having the form of a battery, has several drawbacks, particularly due to a discharge and oxidation process of the battery if the case is not sealed.

Moreover, document KR101255928 proposes a ring-shaped radio device without battery making it possible to use no key-like or housing-like device. However, this device tends to inadvertently trigger or activate the associated system without any control from the holder.

The invention aims to effectively eliminate this drawback by proposing an identification device comprising an annular body incorporating at least one radio-frequency transponder capable of emitting an electromagnetic field carrying identification information, characterized in that said identification device includes a masking device capable of selectively allowing or blocking a propagation of said magnetic field emitted by said radio-frequency transponder.

The invention thus makes it possible to activate or deactivate an identification device according to the will of the holder. This eliminates the risk of inadvertently triggering the element to be controlled.

According to one embodiment, said masking device comprises at least one sliding ring able to rotate relative to said annular body, said sliding ring provided with a field passage zone being able to be moved between a first angular position, in which the field passage zone at least partly faces said radio-frequency transponder so as to enable the propagation of said electromagnetic field, and a second angular position in which said passage zone is angularly shifted with respect to said radio-frequency transponder so as to block the propagation of said electromagnetic field.

According to one embodiment, said field passage zone is made from a non-magnetic material.

According to one embodiment, said field passage zone is formed by an open window in said sliding ring.

According to one embodiment, said identification device comprises notches able to provide the holder with information about its activation state.

According to one embodiment, said identification device incorporates a biometric reading sensor.

According to one embodiment, the masking device is of the electronic type and is able to control the power supply of said transponder.

The object of invention is also an assembly comprising an identification device and a corresponding radio-frequency reader, characterized in that said identification device is supplied with a magnetic field emitted by said radio-frequency reader.

According to one embodiment, said radio-frequency reader is a resonant antenna having an upper resonance frequency of 5 to 20% with respect to a frequency of said electromagnetic field.

According to one embodiment, said radio-frequency reader is integrated into a door handle.

According to one embodiment, said radio-frequency reader is placed inside or outside a vehicle.

According to one embodiment, said identification device is able to act on a configuration of a vehicle for example for locking, unlocking, switching on, preheating, starting and/or setting a driving post.

The invention will be better understood from the following description and annexed figures. These figures are given as an illustration but in no way as a limitation of the invention.

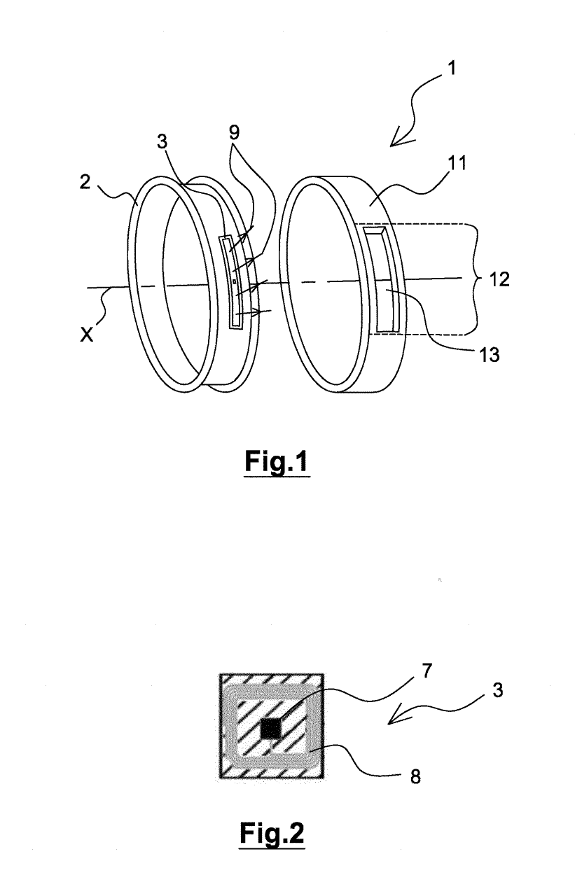

FIG. 1 is an exploded perspective view of the identification device according to the present invention;

FIG. 2 is a front view of a transponder used with the identification device according to the present invention;

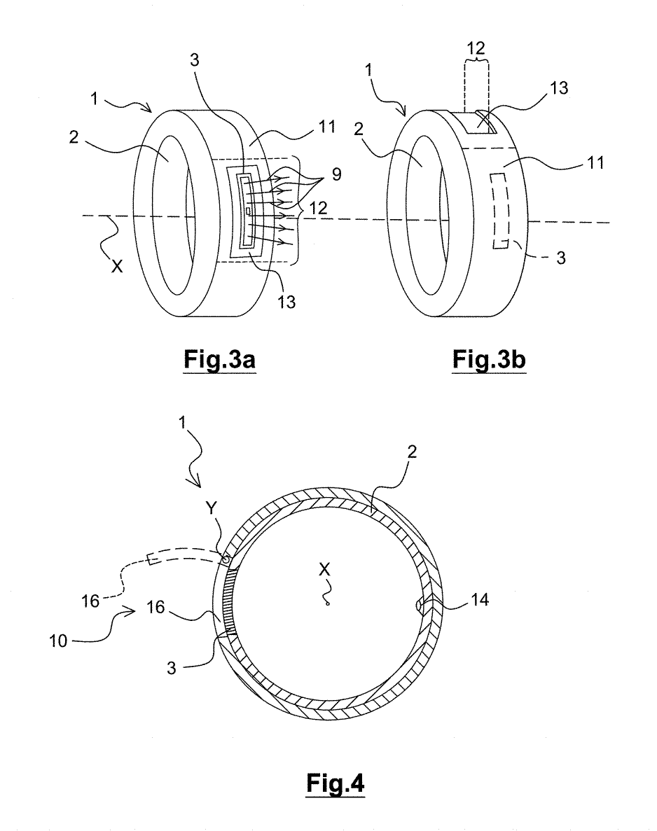

FIGS. 3a and 3b are perspective views of the identification device in FIG. 1 respectively in a first position corresponding to an activated state and in a second position corresponding to a deactivated state;

FIG. 4 is a side view illustrating a second embodiment of the identification device according to the present invention;

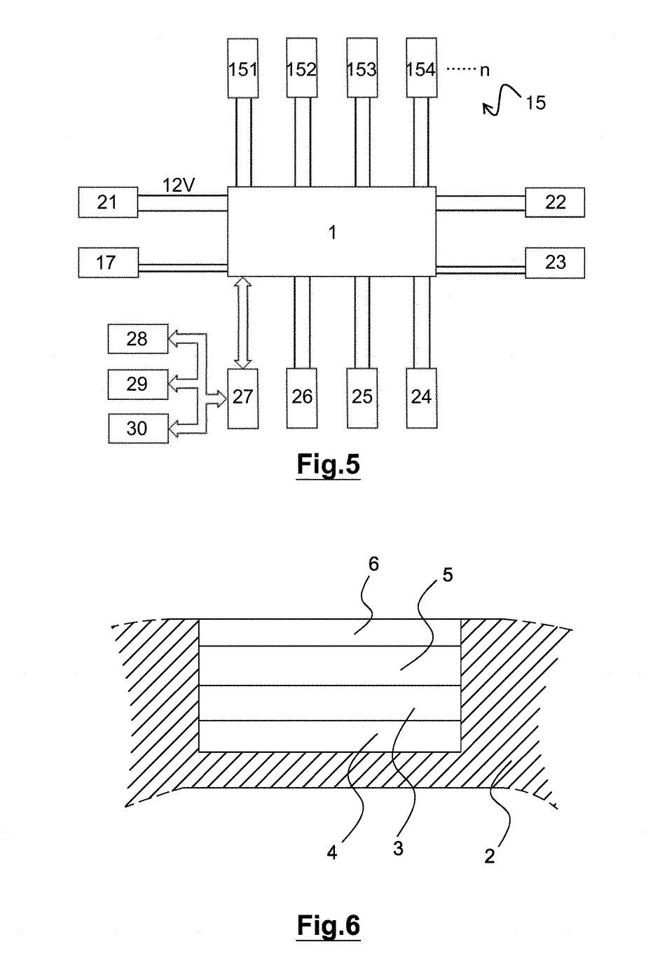

FIG. 5 is a block diagram of the different interactions of the identification device according to the present invention with elements of its environment;

FIG. 6 is a sectional view of the annular body incorporating the transponder according to the present invention;

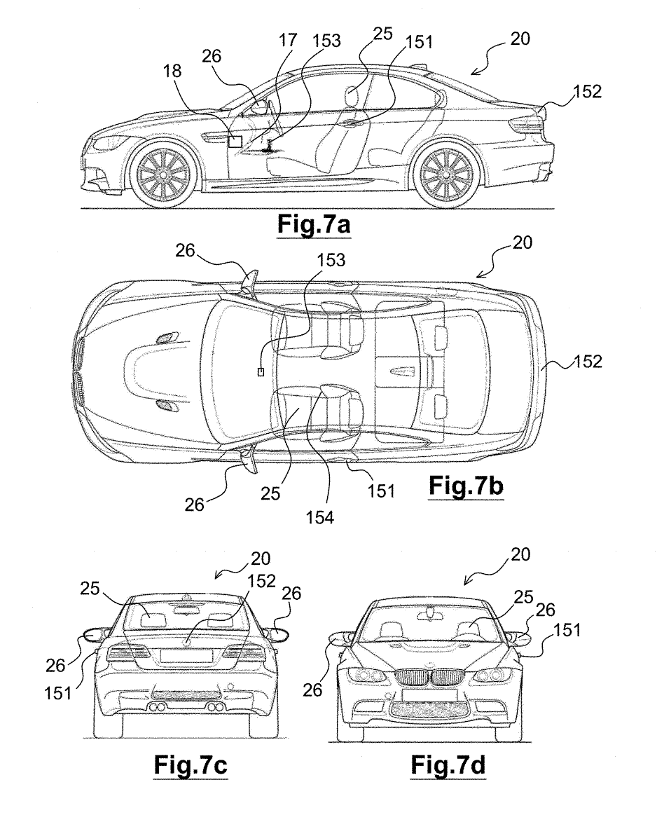

FIGS. 7a to 7d are respectively side, top, bottom and front views of a vehicle equipped with a radio reader for interacting with the identification device according to the present invention.

Identical, similar or analog elements have the same reference in all the figures.

FIG. 1 shows an identification device 1 comprising an annular body 2 integrating a transponder 3 capable of emitting an electromagnetic field 9 which carries identification information for the communication with a corresponding radio reader 15. Alternatively, several transponders 3 can be integrated into the annular body 2 to enable identification by different types of radio readers 15.

In addition, a sliding ring 11 is rotatable relative to the annular body 2 about an axis X. This axis X is common to the body 2 and the sliding ring 11. The sliding ring, which includes a field passage zone 12, is able to be angularly moved between a first position, said activation position, in which the field passage area 12 at least partially faces said transponder 3 so as to enable the propagation of the electromagnetic field 9, and a second position, said deactivation position, in which the field passage area 12 is angularly shifted with respect to the transponder 3 so as to block the propagation of the electromagnetic field 9.

In other words, in the activation position shown in FIG. 3a, the field passage area 12 at least partially overlaps the transponder 3 incorporated in the body 2. The electromagnetic field 9 emitted by the transponder 3 is not then hindered by any obstacle, so that the identification device 1 can communicate with a corresponding radio reader 15.

In the deactivation position shown in FIG. 3b, the transponder 3 is masked by the sliding ring 11 made from a magnetic material. Thus, the electromagnetic field 9 emitted by the transponder 3 is blocked, which enables to interrupt any communication with the radio reader 15.

The zone 12 enabling the passage of the electromagnetic field 9 to the outside of the ring may be formed by an open window 13, whose dimensions correspond to those of the transponder 3. The window 13 passes right through the wall of the sliding ring 11 and may have for example a rectangular, square, oval or any other shape adapted to the configuration of the identification device 1. Alternatively, the field passage zone 12 corresponds to a portion of the ring 11 made from a material enabling the passage of the magnetic field, such as non-magnetic materials like plastic material, a polymer resin or glass.

Notches between the body 2 and the sliding ring 11 may be provided in order to show the holder the angular activation or deactivation position of the sliding ring 11.

In another embodiment, the masking device is of the electronic type. In a non-restrictive manner, the masking device can then have the form of a switch for powering the transponder 3 according to the will of the holder of the identification device 1. The switch may be moved from one activation position, in which the power supply of the transponder 3 by the radio reader 15 is allowed, to a deactivation position, in which the power supply of the transponder 3 by the radio reader 15 is not allowed. The passage from one position of the switch to the other may be controlled for example by the displacement of the sliding ring 11 relative to the annular body 2. Of course, any other equivalent means could be implemented to activate and deactivate the power supply of the transponder 3.

In another embodiment illustrated in FIG. 4, the masking device has the form of a flap 16 rotatable about an axis Y substantially parallel to the axis X. The flap 16 is movable between an activation position, in which the flap 16 is spaced apart relative to the body 2 (see the position represented in discontinuous lines), and a deactivation position, in which the flap 16 covers the transponder 3. Thus, in the activation position, the flap 16 allows the propagation of the electromagnetic field 9 emitted by the transponder 3, so that the latter can communicate with the radio reader 15. In the deactivation position, the flap 16 blocks the electromagnetic field 9 and any communication with the radio reader 15.

The transponder 3, for example of the RFID and/or NFC type, may be sealedly molded in any plastic or metal object allowing the passage of the electromagnetic field 9. The transponder 3 has advantageously the form of a passive label shown in FIG. 2 comprising a chip 7, of the RFID or NFC type, associated with an antenna 8 which captures the energy of a magnetic field emitted by a reader 15. The transponder 3 does not thus require any battery to operate.

The transponder 3 emits an electromagnetic field 9 on predetermined frequencies. The choice of the communication frequency depends on the depth of penetration of a magnetic radiation in materials likely to maintain or cover the transponder 3. The distance for the transponder 3 to be detected by the radio reader 15 is about a few centimeters, for example between 2 and 15 cm and preferably about 4 cm.

In an exemplary embodiment, the frequency of the electromagnetic field 9 is advantageously selected in a low frequency range between 125 and 135 kHz, thus allowing a detection distance adapted to applications in particular in the fields of automobile or home automation. In another exemplary embodiment, the frequency of the electromagnetic field 9 is about 13.56 MHz. This high frequency allows a shorter detection distance ensuring secure communications, such as communications in the field of banking transactions. Of course, the frequency range can be adapted according to the application and the desired detection distance.

In an exemplary embodiment illustrated in FIG. 6, the body 2 is an annular structure made from an alloy of steel and titanium. The transponder 3 is placed on a layer of reflective material 4, whose characteristics will enable to modulate the detection distance. This reflective material 4 may be for example a material derived from aluminum. In addition, a protective layer 5 is molded over the transponder 3. In a final operation, a varnish layer 6 is placed over the protective layer 5. The protection layer 5 and the varnish layer 6 are transparent to the emission field 9 emitted by the transponder 3. In a variant, the protective layer 5 and the varnish layer 6 are one and the same. Of course, the thickness and the choice of the material may be adapted according to the application.

In addition, as shown in FIG. 4, a biometric reading sensor 14 enables to read a fingerprint of a holder of the device 1. The biometric reading sensor 14 is preferably positioned on the inner surface of the body 2. Thus, the reading of the fingerprint is performed when the holder moves the device identification 1 along his finger. The reading is then performed once during the passage of the identification device 1 at the holder's fingerprint. As soon as the identification device 1 is removed, the biometric identification is claimed. This biometric identification acts as a switch enabling the activation and deactivation of the transponder 3 and thus the propagation of the electromagnetic field 9. The biometric reading sensor 14 is supplied by electromagnetic induction, or by any other suitable means such as a source of energy incorporated in the identification device 1.

In the case of an automotive application, the transponder 3 can communicate for example with N directional radio readers (N being an integer greater than or equal to 1) in a vehicle 20. This communication is intended to entitle rights and/or services to the holder of the identification device 1.

To this end, each radio-frequency reader 15 comprises a receiving antenna 3. This antenna preferably has the form of a coil having a rectangular section which is associated with a capacitor to form a resonant antenna. Such an antenna focuses its energy in certain directions and is intended to optimally operate at a certain resonance frequency and for a precise adaptation resistance. To make this antenna less sensitive to surrounding metal elements, its resonance frequency and its resistance adaptation have been adapted.

In an exemplary embodiment, a coil of approximately 3 mH having a resistance of about 250 to 500 ohms offers the radio reader 15 an optimal quality signal. The resonance frequency is not necessarily set to the frequency of the electromagnetic field 9 emitted by the transponder 3. Indeed, a better reception of the electromagnetic field 9 is obtained when the resonance frequency of the antenna of the radio reader 15 is 5 to 20% higher than the frequency of the electromagnetic field 9. The power supply of the radio reader 15 is ensured by a battery 21 inside the vehicle 20, generally delivering a voltage of 12 volts.

This type of radio reader 15 is placed so as to optimize the reading of the electromagnetic field 9 emitted by the transponder 3. As, an example, visible in FIGS. 7a to 7d, four radio readers 15 (N=4), each controlling a different function, are installed on the vehicle 20. The radio readers 15 have been specifically integrated into a door handle 151, a trunk handle 152, a gear lever knob 153, and near a seat belt buckle 154. For a motorcycle, the radio readers 15 can be integrated in the fuel tank or the acceleration handle. In this case, one can note that the electromagnetic field 9 is not much attenuated by a glove-type textile interposed between the transponder 3 and the radio reader 15. The radio readers 15 have the form of a solenoid having about 400 turns with an inductance of about 3 mH. The shape, adaptation resistance, resonance frequency and number N of radio readers 15 are not limited.

Thus, when the holder grasps the handle of a door of the vehicle 20 in order to open it with her/his hand having the identification device 1 in an activated state, the device 1 undergoes electromagnetic induction from the radio reader 151 incorporated in the handle. The induced current, of about 10 μA and 5 V, is sufficient to power the transponder 3 which returns to the antenna of the radio reader 151 a high security identification code which has been preprogrammed during manufacture and is unchangeable. This identification code is then filtered, demodulated and analyzed by a microcontroller located in an electronic circuit 18 near the radio reader 153. The identification device 1 is then recognized, the vehicle 20 is instantly unlocked and the driving post is quickly adapted, in a time of about 4 to 6 seconds.

In order to better control the communication between the identification device 1 and the radio readers 15, a switch 17 controls the power supply of the electronic circuits 18, protected by a case, which enables a radio reader 5 to emit a high magnetic field. In an exemplary embodiment, the case protecting the electronic circuit 18 is about 11 cm long, 6 cm wide and 4 cm thick and is made of aluminum. This case is closed by four safety screws. In this way, the electronic circuit 18 is protected against both theft and other electromagnetic waves.

Preferably, an ignition switch 17 for preheating, starting and stopping the engine of the vehicle 20 is associated with a starting radio reader 153 in the gear lever knob. The switch 17 can be placed in the passenger compartment, within reach of the driver's hand such as on the side of the gear lever knob, near the parking brake, or on the dashboard. Such a switch 17 can be mounted in parallel with the conventional starter system by connecting preheating and starting wires to relevant actuators of the engine or by connecting them to a key switch 23.

Thus, when the driver at the driving post presses the ignition switch 17 and puts her/his hand with the identification device 1 near the starting radio reader 153, the vehicle 20 starts. The vehicle 20 remains in the operating state until the driver presses again the switch 17. For this purpose, the starting radio reader 153 detects the identification device 1 and, when the holder presses the switch 17, the associated reader 153 switches to an off state. In this state, the reader 153 no longer needs identification to keep the motor running. If the switch 17 is pressed again, it will stop the engine of the vehicle 20 and simultaneously switch on the radio reader 153. The radio reader 153 will then claim the high-security identification code of the identification device 1.

The N readers typically switch from a powered state to another according to the locking or unlocking state of the vehicle 20, except for the starting radio reader 153 and the reader 152 in the trunk handle. It is because, whatever the locking or unlocking state of the vehicle 20 is, the reader 152 can actuate cylinders for opening the boot automatically. Of course, each radio reader 15 may also be associated with a switch 17.

As shown in FIG. 5, the identification device 1 can act on a central locking and unlocking control 22, on a key switch 23, on various accessories 24, on a driver's seat 25, on mirrors 26, and on an interface 27 for controlling an on-board computer 28, a GPS 29, and a vehicle configuration 30. These different controls are made via actuators controlling for example the position and the orientation of the mirrors 26, the position, the height, the inclination of the driver's seat 25 and the head support thereof, the steering wheel position. Via a bus connected to an interface 27 adapted to the protocol of communication of the vehicle 20, the device 1 can also act on the display of a computer screen 28, the current radio station, the voice of the GPS 29, the height of the suspensions as well as the hardness thereof, the hardness of the power steering, the driving assistance electronics, the driving style, the power of the vehicle 20 and a possible motor restraining means for young drivers. Preferably, the identification device 1 is synchronized with the absolute time clock sent by the GPS.

Thus, when a holder is authenticated as being the driver of a vehicle 20, he finds each of the settings, accessories 24, and driving types he had programmed. Each new additional setting of the driver during her/his session will be recorded. The invention thus makes it possible to find again the driving post exactly as in the last use, and to restrain the engine for young drivers.

According to the vehicle 20 and the need, the identification device 1 can also be connected to the Internet through a cellular data connection, such as Wifi or Bluetooth. This allows an interaction with the database in the vehicle 20 containing a number of the characteristics thereof, for example and in a non restrictive manner: identification profiles, driving post configuration, driving history, driving schedule planning, fuel consumption, mileage performed or to be performed, the programmed route in the GPS 29, and the actual route.

In addition, several identification devices 1 can be synchronized with the same vehicle 20. The registration of the identification devices 1, the driving post, and the engine configuration is performed by operating a specific command of the electronic circuit 18 in interaction with the microcontroller. So, every holder using the vehicle 20 can be identified. The entire driving post, as well as the characteristics of the engine can be adapted. Time slots of use as well as histories can be recorded. The specific command of the electronic circuit 18 may have the form of a switch, a keypad, or a Internet-type remote access.

The use of such an identification device 1 thus enables a simplified and secure identification. In addition, this device 1, which does not require a battery, does not risk being oxidized. More advantageously, the masking device 11, 16 enables the holder to operate her/his identification device 1 according to her/his will, which avoids any inadvertent operation without the holder's control.

1-11. (canceled)

12. An identification device comprising an annular body incorporating at least one radio frequency transponder configured to emit an electromagnetic field carrying identification information; a masking device configured to selectively allow or block a propagation of said magnetic field emitted by said radio-frequency transponder, said masking device comprising at least one sliding ring rotating relative to said annular body, said at least one sliding ring provided with a field passage zone movable between a first angular position, in which the field passage zone at least partially faces said radio-frequency transponder so as to allow the propagation of said electromagnetic field, and a second angular position, in which the field passage zone is angularly shifted relative to said radio-frequency transponder so as to block the propagation of said electromagnetic field.

13. The identification device according to claim 12, wherein the field passage zone is made from a non-magnetic material.

14. The identification device according to claim 12, wherein the field passage zone is formed by an open window in said at least one sliding ring.

15. The identification device according to claim 12, further comprising notches configured to provide a holder of said identification device with information about an activation status of said identification device.

16. The identification device according to claim 12, further comprising a biometric reading sensor.

17. The identification device according to claim 12, wherein said masking device is of an electronic type and is configured to control a power supply of said transponder.

18. An assembly comprising an identification device according to claim 12 and a radio-frequency reader, wherein said identification device is supplied with a magnetic field emitted by said radio-frequency reader.

19. The assembly according to claim 18, wherein said radio-frequency reader is a resonant antenna having a resonant frequency greater than 5 to 20% with respect to a frequency of said electromagnetic field.

20. The assembly according to claim 18, wherein said radio-frequency reader is incorporated in a door handle.

21. The assembly according to claim 18, wherein said radio-frequency reader is positioned inside or outside of a vehicle.

22. The assembly according to claim 21, wherein said identification device is configured to act on a configuration of the vehicle.

23. The assembly according claim 22, wherein the configuration of the vehicle is at least one of the following: locking of the vehicle, unlocking of the vehicle, switching on an ignition switch to preheat an engine of the vehicle, switching on the ignition switch to start the engine of the vehicle, switching off the ignition switch to stop the engine of the vehicle, and setting a driving position.
